(19) United States
(12) Patent Application Publication
(10) Pub. No.: US 2010/0130277 A1
(43) Pub. Date: May 27, 2010

(54) GAME OF CHANCE

(75) Inventors: John Miller, Seattle, WA (US); Jason York, Bellevue, WA (US); Jeffrey Blazier, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/323,235

(22) Filed: Nov. 25, 2008

(51) Int. Cl. A63F 9/24; A63F 13/00

(52) U.S. Cl. 463/16

(57) ABSTRACT

A game of chance includes receiving a stake from a player. Each phase of the game of chance comprises assigning randomly selected elements to a number of game stops in the form of a pyramidal matrix. Random selection of an element for each game stop is performed independently of random selection for all other game stops. The player is awarded a return based on a composition of elements assigned to the plurality of game stops.

### BACKGROUND

Many people enjoy playing games that include aspects of chance. Such games can be played for fun, with nothing on the line. However, such games are often played with a player staking a bet in hopes of winning cash or other prizes.

### SUMMARY

A game of chance is disclosed. A stake is received from a player and a plurality of game stops are put into play in the form of a pyramidal matrix. Each game stop is assigned an element that is randomly selected from a set of elements from which that game stop draws. Random selection of an element for each game stop is performed independently of random selection for all other game stops. The player is awarded a return based on a composition of elements assigned to the plurality of game stops.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a process flow of an example method of hosting a game of chance.

FIG. 2 shows a pyramidal matrix in the form of a single triangle including three game stops.

FIG. 3 shows a pyramidal matrix in the form of a single triangle including four game stops.

FIG. 4 shows a pyramidal matrix including six game stops.

FIG. 5 shows a table of example element sets for game stops.

FIG. 6 shows an example table of payouts for a game of chance.

FIG. 7 shows an example scenario in a game of chance with three game stops.

FIG. 8 shows another example scenario in a game of chance with three game stops.

FIG. 9A-9B show an example sequence of phases of a game of chance including a bonus phase with a fourth game stop.

FIG. 10A-10B show an example sequence of phases of a game of chance including a bonus phase with a fourth game stop.

FIG. 11A-11B show an example sequence of phases of a game of chance with six game stops.

FIG. 12 schematically shows a computing system that may host a game of chance.

### DETAILED DESCRIPTION

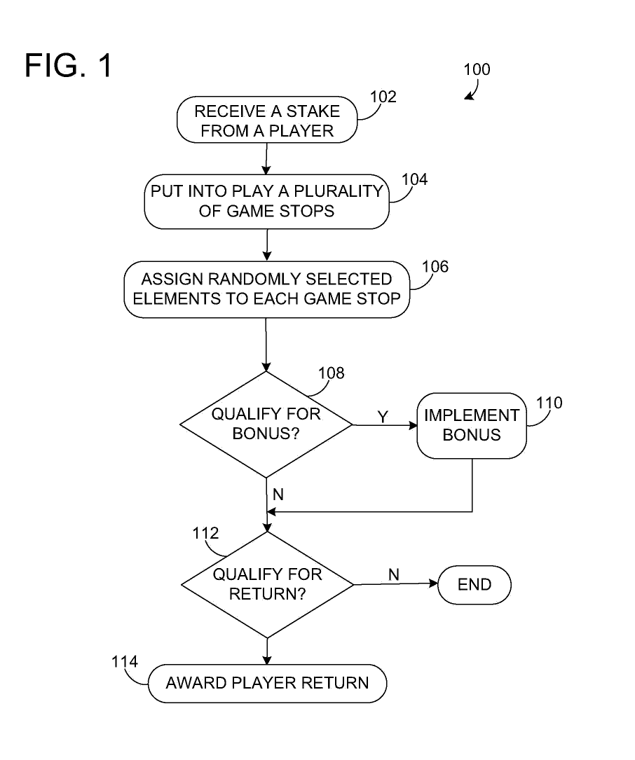

FIG. 1 shows a process flow of an example method 100 of hosting a game of chance. A game of chance can be hosted in a variety of different manners without departing from the scope of this disclosure. In some embodiments, a game of chance can be hosted as a live slot machine game, analogous to a live slot machine game hosted at a casino. In other embodiments, a game of chance can be hosted as a video game of chance, analogous to a video slot machine game in a casino. In still other embodiments, a game of chance can be hosted as a game played on a computing device, such as a personal computer, console gaming machine, portable gaming machine, personal data assistant, mobile communications device, or any other suitable computing device. When hosted on a computing device, the game of chance can be served from a remote server or executed from locally saved instructions. Further, in some embodiments, a game of chance can be a game within a game, such as a slot machine game that can be played by gaming characters existing in a virtual game world.

At 102, method 100 includes receiving a stake from a player. The stake may take a variety of different forms depending on the manner in which the game of chance is being hosted. In a casino slot machine game, the stake may take the form of a cash or cash equivalent (e.g., tokens) wager. In a video game, the stake may be a submission of one or more virtual dollars or points, which may or may not correspond to cash or other value outside of the game. In some embodiments, the initial stake may simply be acceptance by a player to play the game. As explained in more detail below, a particular amount (e.g., 5 dollars or points) may be set as a base stake, and the amount of any return (i.e., winnings) is proportional to the actual stake wagered by a player. For example, winnings from a 10 dollar or 10 point stake are twice as big as winnings from a 5 dollar or 5 point stake.

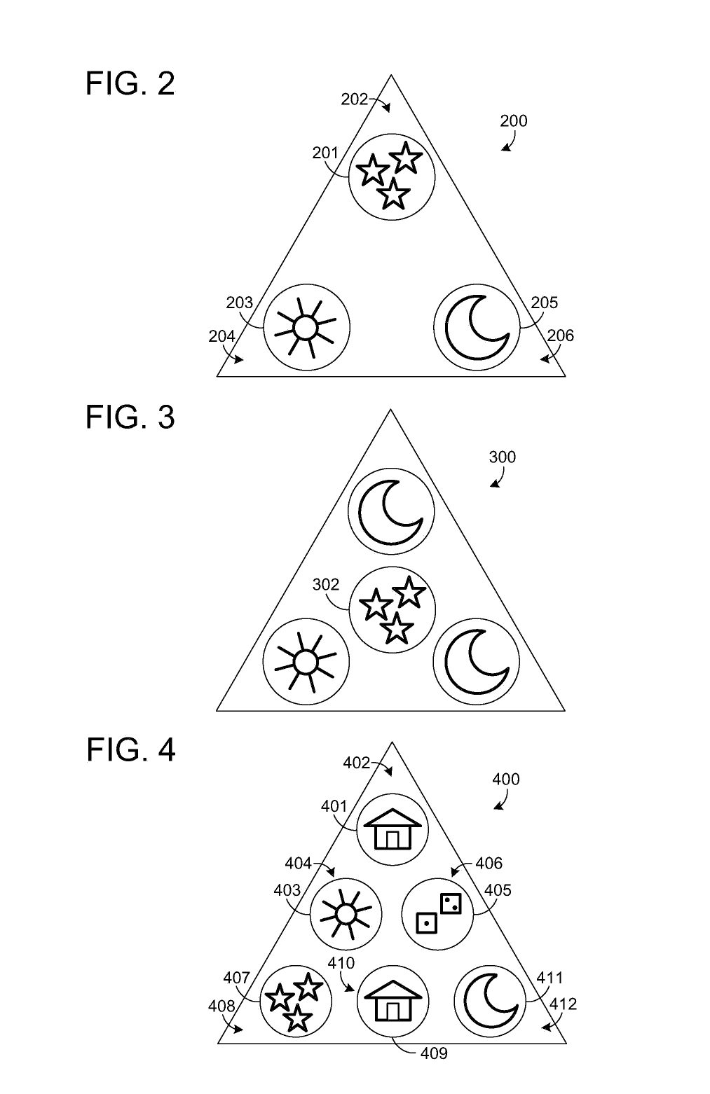

At 104, method 100 includes putting into play a plurality of game stops, each of which is positioned at a vertex of one or more triangles. For example, FIG. 2 shows a pyramidal matrix 200 in the form of a single triangle which contains three vertices. Thus, there are three game stops in this example: a first game stop 201 being located at a first vertex 202, a second game stop 203 being located at a second vertex 204, and a third game stop 205 being located at a third vertex 206. In some variations, the plurality of game stops further includes a fourth game stop positioned interior the triangle, as shown at 302 of pyramidal matrix 300 in FIG. 3. In other variations, the plurality of game stops includes six game stops positioned in a pyramidal matrix. For example, FIG. 4 shows a pyramidal matrix 400 including a first game stop 401 located at exterior vertex 402, a second game stop 403 located at interior vertex 404, a third game stop 405 located at interior vertex 406, a fourth game stop 407 located at exterior vertex 408, a fifth game stop 409 located at interior vertex 410, and a sixth game stop 411 located at exterior vertex 412. It is to be understood the number of game stops is not limited to three, four, or six game stops. Any number of game stops positioned in a pyramidal matrix may be used without departing from the scope of this disclosure.

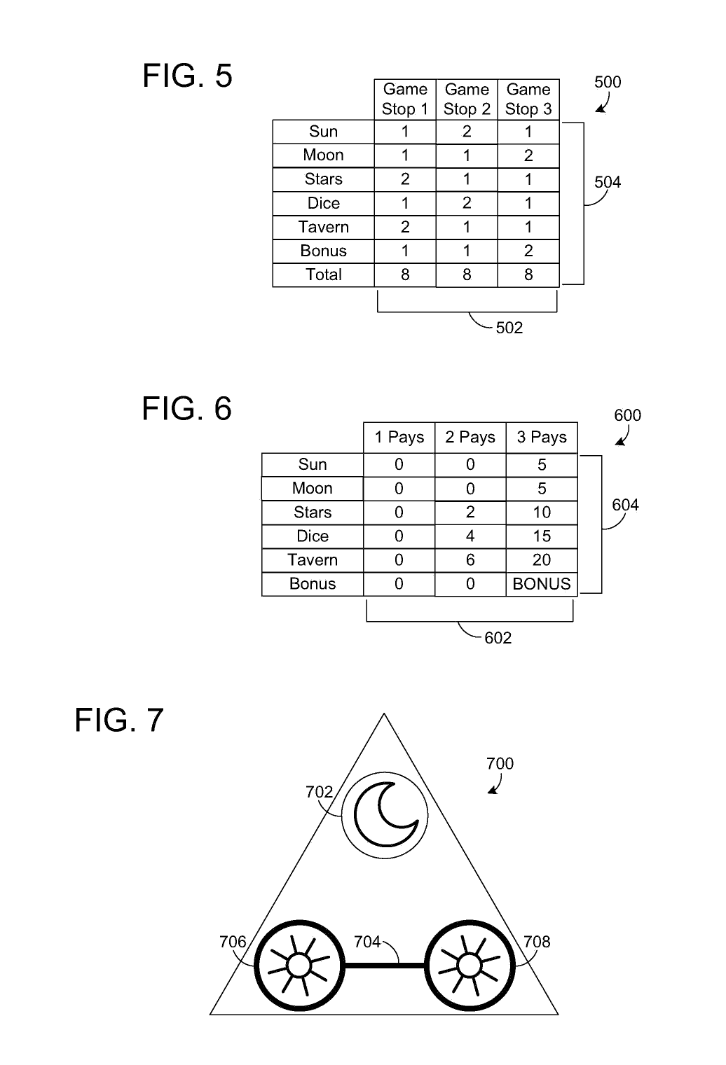

Each game stop has a set of elements from which it draws. The set of elements, or recipe, for each game stop may be the same as the recipe for one or more other game stops, or the recipe for each game stop may be different than the recipes for all other game stops. As used herein, “recipe” refers to the combination of elements available in the set for each game stop. Table 500 in FIG. 5 shows example recipes for game stops in a variation of a game of chance that uses three game stops. The different columns 502 of table 500 correspond to different game stops, and the different rows 504 correspond to the different elements from which the corresponding game stop may draw. The number at the intersection of each column and row indicates the number of relevant elements in the recipe for the relevant game stop (e.g., the recipe for “Game Stop 1” includes 2 “Stars” elements). In this example, each set contains a total of eight elements as shown in the seventh row of table 500; however, there may be any number of elements in each recipe, the number of which may vary by game stop and/or by the variation of the game of chance being played. In some embodiments, the recipe for one or more game stops includes at least one bonus element, as shown in the sixth row of table 500.

Turing back to FIG. 1, at 106, method 100 includes assigning to each game stop a randomly selected element from the set of elements from which that game stop draws. The random selection of an element for each game stop may be independent of selection for all other game stops. In other words, the random selection of an element for a first game stop may not affect the outcome of the random selection of all other game stops. For example, in FIG. 2, a randomly selected element (e.g., stars) is assigned to the game stop 201 at the first vertex 202 of the pyramidal matrix 200, a randomly selected element (e.g., sun) is independently assigned to the game stop 203 at the second vertex 204 of the pyramidal matrix 200, and a randomly selected element (e.g., moon) is independently assigned to the game stop 205 at the third vertex 206 of the pyramidal matrix 200. Assigning of elements may occur simultaneously for all game stops or each game stop may be assigned an element in succession with some amount of time between assignments. As an example, in a game of chance with a plurality of three game stops, a first game stop may be assigned an element first, then a second game stop may be assigned an element, and finally, a third game stop may be assigned an element. In other embodiments, all three game stops may be independently assigned elements at the same time, or at almost the same time.

At 108 of method 100 in FIG. 1, it is determined if any of the assigned elements are bonus elements, which qualify the player for a bonus phase as explained in greater detail below. In some embodiments of the game of chance, the recipes for each game stop may not include bonus elements; thus, bonus elements cannot be assigned and method 100 proceeds to 112 where it is determined if the player qualifies for a return.

The return a player receives at 114 of method 100 is based on the composition of elements assigned to the plurality of game stops. The return is proportional to the number of game stops in an unbroken chain of matching assigned elements. Table 600 of FIG. 6 shows an example of payouts for a game of chance including three game stops. The different columns 602 of table 600 correspond to the number of game stops with matching elements that form an unbroken chain, and the different rows 604 correspond to the different elements. The number at the intersection of each column and row indicates the payout for the relevant number of game stops in an unbroken chain of matching assigned elements (e.g., a “Stars” element in an unbroken chain of “2” pays out 2 times the amount of the stake wagered). In many embodiments, if the number of game stops in an unbroken chain of matching assigned elements is less than two, the return awarded to the player is nil (i.e., the player loses). In general, the greater the number of game stops with matching assigned elements that form an unbroken chain, the greater the payout. As a nonlimiting example, in table 600 of FIG. 6, an unbroken chain of 2 dice elements has a payout of 4 and an unbroken chain of 3 dice elements has a payout of 15; thus, a chain of three game stops with matching assigned elements pays out a greater amount than a chain of two game stops with matching assigned elements.

Further, in some variations, the player may be awarded a return that depends on which type of elements match in the unbroken chain. For example, pyramidal matrix 700 of FIG. 7 shows one moon element at game stop 702 and two sun elements that form an unbroken chain 704 of two game stops with matching elements, namely game stop 706 and game stop 708. If the relevant payout table for the example in FIG. 7 was that of FIG. 6, an unbroken chain of two sun elements would have a payout of zero; therefore, the player is not awarded a return. If the matching elements were stars, dice, or tavern elements, however, the player would be awarded a return according to table 600.

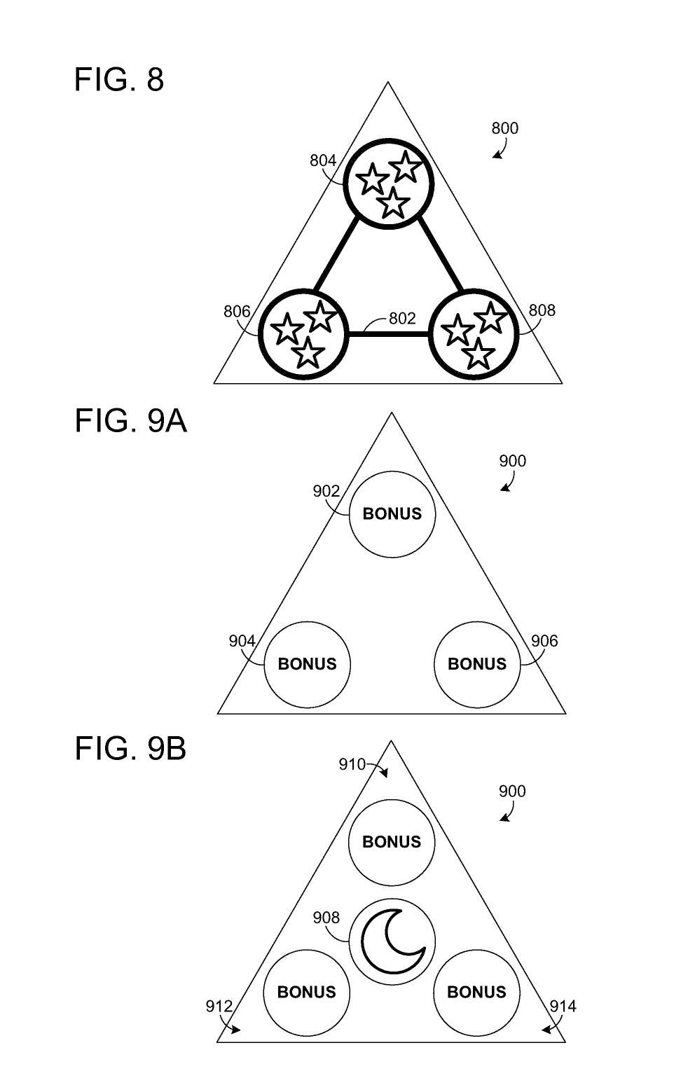

In FIG. 8, the pyramidal matrix 800 includes three game stops (i.e., game stop 804, game stop 806 and game stop 808) that are each assigned stars elements, forming an unbroken chain 802 of three game stops with matching assigned elements. According to table 600 of FIG. 6, an unbroken chain of 3 stars elements results in a return that is ten times greater than the stake. Furthermore, an unbroken chain of three stars elements pays more than an unbroken chain of three sun or moon elements, but less than an unbroken chain of three dice or tavern elements.

In some embodiments, the game of chance may include a plurality of six game stops positioned in a pyramidal matrix 400 of FIG. 4, with a first game stop 401, a second game stop 403, a third game stop 405, a fourth game stop 407, a fifth game stop 409, and a sixth game stop 411. In such a configuration, an unbroken chain of matching assigned elements may include as many as six game stops resulting in a payout of 6 for the assigned element. There are two matching elements (e.g., tavern) at game stops 401 and 409 in the example of FIG. 4. The return awarded to the player is nil, however, as the matching tavern elements do not form an unbroken chain.

Turning back to FIG. 1, at 108, it is determined if the player qualifies for a bonus phase of the game of chance. If at least one of the plurality of game stops is assigned a bonus element, method 100 may proceed to 110 where a bonus phase of the game of chance may be implemented. As described by way of example below, a bonus phase may be implemented in a variety of different ways. In some variations, a threshold number of bonus elements may initiate a subsequent phase of the game that is “free” for the player (i.e., the player is not required to wager an additional stake).

FIG. 9A shows a game of chance in which a pyramidal matrix 900 including three game stops is used. In the illustrated example, the first game stop 902, the second game stop 904, and the third game stop 906 are all assigned a bonus element. In this example, a bonus phase is initiated as shown at 110 in FIG. 1. In this example version of a bonus phase, a fourth game stop 908 (i.e., a bonus game stop) is added, as shown in FIG. 9B. Game stop 908 is positioned interior the first vertex 910, the second vertex 912, and the third vertex 914 of pyramidal matrix 900. The fourth game stop 908 is assigned a randomly selected element from a fourth set of elements, which may optionally include at least one bonus element. The player is awarded a return based on the element assigned to the fourth game stop, and such return is set to be equivalent to the return the player would receive if all three of the original game stops were assigned the element that is assigned to the fourth game stop 908. In the example of FIG. 9B, the fourth game stop 908 is assigned a moon element, thus, the player is awarded a return equal to the return awarded for the assignment of three moon elements in a non-bonus phase (e.g., a return of if table 600 from FIG. 6 is used to calculate the return).

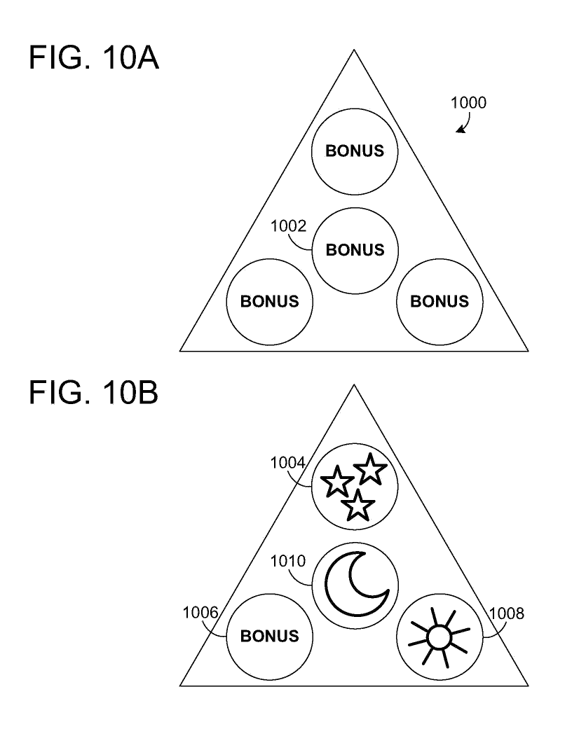

Pyramidal matrix 1000 of FIG. 10A shows a bonus phase scenario in which the fourth game stop 1002 is assigned a bonus element. If the fourth game stop is assigned a bonus element, a next bonus phase may be initiated. In the next bonus phase, all four game stops are independently assigned a randomly selected element. The return awarded to the player is equivalent to the sum of the return the player would receive if all three of the original game stops were assigned the same element as the assigned element for each game stop. For example, in FIG. 10B, the first game stop 1004 is assigned a fifth element (e.g., stars), the second game stop 1006 is assigned a sixth element (e.g., bonus), the third game stop 1008 is assigned a seventh element (e.g., sun), and the fourth game stop 1010 is assigned an eighth element (e.g., moon). Therefore, the return awarded to the player in this example is equal to the sum of the payout for an unbroken chain of three stars, the payout for an unbroken chain of three suns, and the payout for an unbroken chain of three moons. The return for a bonus element in this example is nil and the assignment of a single bonus element in this variation does not initiate a subsequent bonus phase.

In other variations, a bonus game stop may be added at a location other than the interior of the vertices of a single triangle in the pyramidal matrix. For example, the bonus game stop may be added as a separate entity outside the pyramidal matrix.

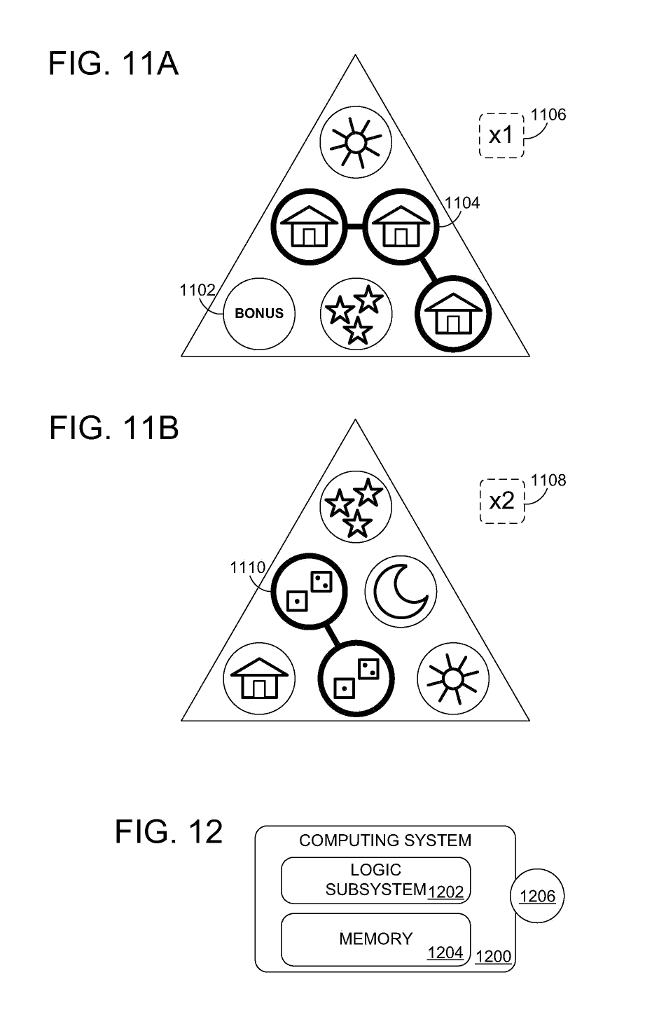

In further embodiments, in which the set of elements from which each game stop draws includes at least one bonus element, assignment of one or more bonus elements may initiate a bonus phase as shown at 110 in FIG. 1. As an example, the return awarded to the player during a bonus phase may be modified by an active multiplier carried over from an immediately previous phase of the game of chance. Each bonus element assigned to a game stop adds one to the active multiplier. For example, the active multiplier at 1106 of FIG. 11A is ×1 (i.e., the payout is multiplied by 1). In this example, there are three tavern elements that form an unbroken chain 1104 of three game stops; thus, the return awarded to the player is 20 (i.e., 1×20) if table 600 from FIG. 6 is used to calculate the return. Game stop 1102 in the example of FIG. 11A is assigned a bonus element, thus the active multiplier is increased by one (i.e., the active multiplier becomes ×2) in the subsequent bonus phase of the game of chance, as indicated at 1108 in FIG. 11B.

At 1108 of FIG. 11B, the active multiplier is ×2 due to the assignment of one bonus element in the immediately previous phase of the game of chance. In this example, two of the plurality of six game stops are assigned matching elements (e.g., dice element). The assigned dice elements form an unbroken chain 1110 of two game stops, which results in a return of 6 if table 600 from FIG. 6 is used to calculate the return. However, due to the active multiplier of ×2 at 1108, the return awarded to the player is multiplied by two, thus becoming a payout of 12 (i.e., 2×6). If the number of bonus elements assigned in a bonus phase is zero, as in the example of FIG. 11B, the active multiplier is reset to ×1. If, however, one or more bonus elements are assigned in a bonus phase of the game of chance, the active multiplier is further increased by the number of assigned bonus elements. As an example, if the active multiplier is ×2 and two bonus elements are assigned in a bonus phase, the active multiplier increases to ×4 in the immediately subsequent bonus phase. The active multiplier may continue to be increased until no bonus elements are assigned to any game stops.

The fourth game stop and active multiplier bonus games described above are provided as two example bonus games. Other bonus games are considered to be within the scope of this disclosure. For example, if a player may be awarded a free bonus phase for each bonus element assigned to a game stop. As another example, a bonus phase may be initiated in which all game stops previously assigned bonus elements are reassigned game elements that were assigned to other game stops.

In some embodiments, a game of chance in accordance with the present disclosure may be hosted by a variety of different computing devices. FIG. 12 schematically shows a computing device 1200 that may host a game of chance. Computing device 1200 includes a logic subsystem 1202 and memory 1204.

Logic subsystem 1202 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, change the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Memory 1204 may include one or more physical devices configured to hold data and/or instructions that, when executed by the logic subsystem, cause the logic subsystem to implement the herein described methods and processes. Memory 1204 may include removable media and/or built-in devices. Memory 1204 may include optical memory devices, semiconductor memory devices, and/or magnetic memory devices, among others. Memory 1204 may include portions with one or more of the following characteristics: volatile, nonvolatile, dynamic, static, read/write, read-only, random access, sequential access, location addressable, file addressable, and content addressable. In some embodiments, logic subsystem 1202 and memory 1204 may be integrated into one or more common devices and/or computing systems.

FIG. 12 also shows memory in the form of removable media 1206, which may be used to store and/or transfer instructions that, when executed, perform the herein described methods and processes.

It should be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of hosting a game of chance, the method comprising:
receiving a stake from a player;
putting into play a plurality of game stops, each game stop positioned at a vertex of one or more triangles and each game stop drawing from a set of elements;
assigning to each game stop an element randomly selected from the set of elements from which that game stop draws, random selection of an element for each game stop being independent of selection for all other game stops; and
awarding the player a return based on a composition of elements assigned to the plurality of game stops.

2. The method of claim 1, where the return awarded to the player is proportional to a number of game stops in an unbroken chain of matching assigned elements.

3. The method of claim 2, where the return awarded to the player is nil if the number of game stops in an unbroken chain of matching assigned elements is less than two.

4. The method of claim 2, where the return awarded to the player depends on which type of elements match in the unbroken chain.

5. The method of claim 1, where the plurality of game stops includes three game stops positioned at the vertices of a single triangle.

6. The method of claim 5, where the plurality of game stops further includes a game stop positioned interior the single triangle.

7. The method of claim 1, where the plurality of game stops includes six game stops positioned in a pyramidal matrix.

8. The method of claim 1, where each game stop draws from a different set of elements.

9. The method of claim 1, where each game stop draws from a set of elements including at least one bonus element.

10. The method of claim 9, where if three or more of the plurality of the game stops are assigned bonus elements, then initiating a bonus phase of the game of chance, the bonus phase comprising:
assigning an element randomly selected from a set of elements to a bonus game stop; and
awarding the player a return based on the element assigned to the bonus game stop.

11. The method of claim 9, where the return is modified by an active multiplier carried over from an immediately previous phase of the game of chance and the method further comprises:
increasing the active multiplier for each bonus element assigned to any game stop if one or more bonus elements are assigned to one or more game stops; or
resetting the active multiplier if no bonus element is assigned to any game stop; and then
modifying a return in an immediately subsequent phase of the game of chance by the active multiplier.

12. A method of hosting a game of chance, the method comprising:
receiving a stake from a player;
assigning a first element randomly selected from a first set of elements to a first game stop positioned at a first vertex of a first triangle, the first set of elements including at least one bonus element;
assigning a second element randomly selected from a second set of elements to a second game stop positioned at a second vertex of the first triangle, the second set of elements including at least one bonus element;
assigning a third element randomly selected from a third set of elements to a third game stop positioned at a third vertex of the first triangle, the third set of elements including at least one bonus element;
if the first element and the second element and the third element are all bonus elements, then initiating a bonus phase of the game of chance, the bonus phase comprising:
assigning a fourth element randomly selected from a fourth set of elements to a fourth game stop; and
awarding the player a return based on the fourth element.

13. The method of claim 12, further comprising initiating a next bonus phase of the game of chance if the fourth element is assigned a bonus element, the next bonus phase including:
assigning a fifth element randomly selected from the first set of elements to the first game stop;
assigning a sixth element randomly selected from the second set of elements to the second game stop;
assigning a seventh element randomly selected from the third set of elements to the third game stop; and
assigning an eighth element randomly selected from the fourth set of elements to the fourth game stop; and
awarding the player a return based on a composition of the fifth element, the sixth element, the seventh element, and the eighth element.

14. The method of claim 12, further comprising awarding the player a return based on a composition of elements assigned to the first game stop, the second game stop, and the third game stop, where such return is proportional to a number of game stops in an unbroken chain of matching assigned elements.

15. The method of claim 14, where the return awarded to the player is nil if the number of game stops in an unbroken chain of matching assigned elements is less than two.

16. The method of claim 14, where the return awarded to the player depends on which type of elements match in the unbroken chain.

17. A method of hosting a game of chance, the method comprising:
receiving a stake from a player;
putting into play a plurality of game stops, each game stop drawing from a set of elements including one or more bonus elements;
assigning to each game stop an element randomly selected from the set of elements from which that game stop draws;
awarding the player a return based on a composition of elements assigned to the plurality of game stops as modified by an active multiplier carried over from an immediately previous phase of the game of chance; and
increasing the active multiplier for each bonus element assigned to any game stop if one or more bonus elements are assigned to one or more game stops; or
resetting the active multiplier if no bonus element is assigned to any game stop; and then
modifying a return in an immediately subsequent phase of the game of chance by the active multiplier.

18. The method of claim 17, where the plurality of game stops are arranged in a pyramidal matrix.

19. The method of claim 17, where the return is proportional to a number of game stops in an unbroken chain of matching assigned elements.

20. The method of claim 19, where the return awarded to the player depends on which type of elements match in the unbroken chain.
